(19) United States
(12) Patent Application Publication
(10) Pub. No.: US 2026/0044618 A1
(43) Pub. Date: Feb. 12, 2026

(54) METHOD AND SYSTEM FOR PROVIDING PERSONAL INFORMATION SERVICES THROUGH MANAGING ACCESS KEY FOR CONTROLLING DYNAMIC ACCESS TO PDS

(71) Applicants: THE CATHOLIC UNIVERSITY OF KOREA INDUSTRY-ACADEMIC COOPERATION FOUNDATION, Seoul (KR); Intellicode Inc., Suwon-si (KR)

(72) Inventors: Taehoon KO, Seoul (KR); Tong Min KIM, Seoul (KR); Byoung Woo HWANG, Suwon-si (KR); Wan Yeon LEE, Seoul (KR); Hyung Goo PAEK, Busan (KR); Yun Gi PARK, Seoul (KR)

(73) Assignees: THE CATHOLIC UNIVERSITY OF KOREA INDUSTRY-ACADEMIC COOPERATION FOUNDATION, Seoul (KR); Intellicode Inc., Suwon-si, Gyeonggi-do (KR)

(21) Appl. No.: 19/278,399

(22) Filed: Jul. 23, 2025

(30) Foreign Application Priority Data
Aug. 6, 2024 (KR) 10-2024-0104969

(51) Int. Cl. G06F 21/62; G06F 21/30; G06F 21/60

(52) U.S. Cl. CPC G06F 21/6218; G06F 21/30; G06F 21/602

(57) ABSTRACT

The present invention provides a method and a system for providing personal information services through managing access key for controlling dynamic access to PDS. The method includes: receiving, by a PDS, a storage space generation request signal from a user terminal; by the PDS, storing authentication information of a data service server and access number information, generating a user storage space, and transmitting address information of the user storage space and access-related information to the user terminal; by the data service server, generating an access key based on the access-related information and its own authentication information and transmitting a service request signal to the PDS, wherein the service request signal includes the access key; and by the PDS, verifying validity of the access key and performing a service when the access key is valid; wherein the access-related information includes the access number information and time information.

### CROSS-REFERENCE TO RELATED APPLICATION

This application claims the benefit of Korean Patent Application No. 10-2024-0104969 filed on Aug. 6, 2024, which is hereby incorporated by reference herein in its entirety.

### BACKGROUND

### 1. Technical Field

The present invention relates to a method and system for providing personal information services and more particularly, to a method and system for providing personal information services through managing access key for controlling dynamic access to Personal Data Store (PDS) that may enhance security by allowing a data service server to dynamically perform authentication for a PDS.

### 2. Description of the Related Art

Recently, there has been proposed a method that enables pieces of personal information collected and managed in a central system conventionally, to be distributed to personal repositories and managed by individuals themselves by using PDS (Personal Data Store/Personal Data Service) technology.

PDS technology is a key technology constituting the Web 3 Internet structure. The Internet structure is currently evolving from the existing centralized Web 1 and Web 2 structures to the decentralized Web 3 structure.

In order to solve the problem of the existing Web 1 and Web 2 structures in which digital information is concentrated in a small number of large Internet companies and also the profits from Internet information exchange are concentrated in the small number of large Internet companies, the Web 3 structure has been proposed as the next-generation Internet structure and related research has been actively conducted recently.

In the Web 1 and Web 2 structures, personal information is managed by third-party companies whereas in the Web 3 structure, the sovereignty of personal information is completely transferred to the owners of the personal information and others can access only to the information permitted by the owners of the personal information.

Furthermore, to return the profits generated from information exchange over the Internet to individuals with this self-control function for access to personal information is the main purpose of PDS-related technology.

In conventional PDS technology, authentication between a data service server requesting information and a PDS is processed using an API key. However, according to this API key authentication method, authentication for a data service server is performed by API key issued to a specific individual. Thus, a problem arises in that it is difficult to prevent illegal use by another person when the API key issued to the specific individual is exposed. In addition, there is also a problem in that it is difficult either for the individual user or the PDS to control restrictions on the number of times the API key can be used in detailed manner.

### SUMMARY

The present invention has been conceived to overcome the above-described problems, and an object of the present invention is to provide a method and system for providing personal information services through managing access key for controlling dynamic access to Personal Data Store (PDS) that may enhance security by allowing a data service server to dynamically perform authentication for a PDS.

Another object of the present invention is to provide a method and system that may prevent the illegal misappropriation, unauthorized use or theft of user information by distinguishing operations executed in the PDS, dynamically changing or updating access number information indicating the maximum number of times access to the data service server is allowed according to the executed operation and performing authentication for the PDS based on the dynamically changed or updated access number information.

According to an aspect of the present invention, there is provided a method for providing personal information services through managing access key for controlling dynamic access to Personal Data Store (PDS), the method including: a first step of receiving, by a PDS, a storage space generation request signal from a user terminal; a second step of storing, by the PDS, authentication information of a data service server and access number information indicating the maximum number of times access to the data service server is allowed included in the storage space generation request signal, generating, by the PDS, a user storage space, and then transmitting, by the PDS, address information of the user storage space and access-related information to the user terminal, wherein the user terminal transmits the address information of the user storage space and the access-related information to the data service server; a third step of generating, by the data service server, an access key based on the access-related information and its own authentication information; a fourth step of transmitting, by the data service server, a service request signal to the PDS, wherein the service request signal includes the access key; and a fifth step of verifying, by the PDS, validity of the access key, and performing, by the PDS, a service corresponding to the service request signal when the access key is valid; wherein the access-related information includes the access number information and time information.

In the third step, the access key may be a result value of a hash function having the access number information, the time information and the authentication information of the data service server as its inputs; and in the fifth step, the PDS may calculate the result value of the hash function having the authentication information of the data service server and the access number information stored previously and the time information used when the access-related information is generated as its inputs, may compare the calculated result value with the access key transmitted from the data service server and may determine that the access key is valid when the calculated result value is identical to the access key.

The access number information may include operation information indicating the number of times each of read operation, write operation and modify operation for user information stored in the PDS is allowed.

The PDS may execute at least any one of read operation, write operation and modify operation for stored user information to perform the service corresponding to the service request signal and then may update the operation information for the executed operation by deducting the number of times the operation has been executed.

The data service server may update the operation information for read operation, write operation and modify operation it stores by deducting the number of times the operation has been executed by the PDS.

The PDS, when the access number information reaches a preset lower limit, may receive the access number information from the user terminal again, may generate new access-related information and may perform steps following the third step.

According to another aspect of the present invention, there is provided a system for providing personal information services through managing access key for controlling dynamic access to Personal Data Store (PDS), the system including: a PDS configured to receive a storage space generation request signal from a user terminal, to store authentication information of a data service server and access number information indicating the maximum number of times access to the data service server is allowed included in the storage space generation request signal, to generate a user storage space and to transmit address information of the user storage space and access-related information to the user terminal; and the data service server configured to receive the address information of the user storage space and the access-related information from the user terminal; wherein the data service server generates an access key based on the access-related information and its own authentication information and transmits a service request signal including the access key to the PDS; wherein the PDS verifies validity of the access key and performs a service corresponding to the service request signal when the access key is valid; and wherein the access-related information includes the access number information and time information.

The access key may be a result value of a hash function having the access number information, the time information and the authentication information of the data service server as its inputs; and the PDS may calculate the result value of the hash function having the authentication information of the data service server and the access number information stored previously and the time information used when the access-related information is generated as its inputs, may compare the calculated result value with the access key transmitted from the data service server and may determine that the access key is valid when the calculated result value is identical to the access key.

The access number information may include operation information indicating the number of times each of read operation, write operation and modify operation for user information stored in the PDS is allowed.

The PDS may execute at least any one of read operation, write operation and modify operation for stored user information to perform the service corresponding to the service request signal and then may update the operation information for the executed operation by deducting the number of times the operation has been executed.

The data service server may update the operation information for read operation, write operation and modify operation it stores by deducting the number of times the operation has been executed by the PDS.

The PDS, when the access number information reaches a preset lower limit, may receive the access number information from the user terminal again and may generate new access-related information.

According to the present invention, there are provided the method and the system for providing personal information services through managing access key for controlling dynamic access to Personal Data Store (PDS) that may enhance security by allowing a data service server to dynamically perform authentication for a PDS.

In addition, thereby are provided the method and system that may prevent the illegal misappropriation, unauthorized use or theft of user information by distinguishing operations executed in the PDS, dynamically changing or updating access number information indicating the maximum number of times access to the data service server is allowed according to the executed operation and performing authentication for the PDS based on the dynamically changed or updated access number information.

### BRIEF DESCRIPTION OF THE DRAWINGS

The above and other objects, features, and advantages of the present invention will be more clearly understood from the following detailed description taken in conjunction with the accompanying drawings, in which:

FIG. 1 shows the overall configuration and connection relationship of a system for providing personal information services through managing access key for controlling dynamic access to Personal Data Store (PDS) according to one embodiment of the present invention;

FIG. 2 is a flowchart showing an embodiment of a method for providing personal information services through managing access key for controlling dynamic access to Personal Data Store (PDS) that is performed by the system;

FIG. 3 shows an example of access number information indicating the maximum number of times access to the data service server is allowed; and

FIG. 4 is a diagram showing a process of changing access number information.

### DETAILED DESCRIPTION

Embodiments of the present invention will be described in detail below with reference to the accompanying drawings.

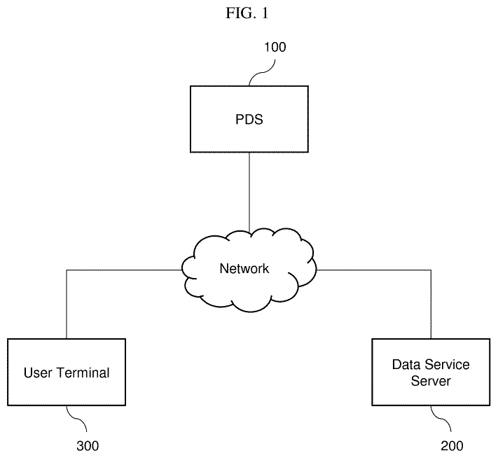

FIG. 1 shows the overall configuration and connection relationship of a system 10 for providing personal information services (hereinafter simply referred to as the “system 10”) through managing access key for controlling dynamic access to PDS according to one embodiment of the present invention.

Referring to FIG. 1, the system 10 includes a PDS 100 and a data service server 200.

The PDS (Personal Data Store) 100 is connected to the data service server 200 and a user terminal 300 over a network and is configured to store data required to perform data service in the data service server 200.

The PDS 100 stores user information such as a user's medical information or financial information, receives a service request signal for a specific user from the data service server 200 and performs a service corresponding to the service request signal when the service request signal is valid.

The data service server 200 is one of the servers that perform conventionally-known various services based on user information over a network, such as a medical institution server, a financial institution server, a government office server and a social media service server. In the present invention, it does not matter what service the data service server 200 provides.

The user terminal 300 is a conventionally-known device such as a computer or a smartphone and refers to a terminal of a user who desires to store information related to himself or herself, that is, user information in the PDS 100 and to provide the user information to the data service server 200.

This system 10 is characterized by operating as follows: First, the user terminal 300 transmits a storage space generation request signal to the PDS 100 and the PDS 100 generates a user storage space for the corresponding user and then transmits the address information of the user storage space and access-related information to the user terminal 300.

Then, the user terminal 300 transmits the address information of the user storage space and the access-related information to the data service server 200.

The, when the data service server 200 needs the user information of the corresponding user, the data service server 200 transmits a service request signal including an access key to the PDS 10. When the access key is valid, the PDS 100 performs a service corresponding to the service request signal.

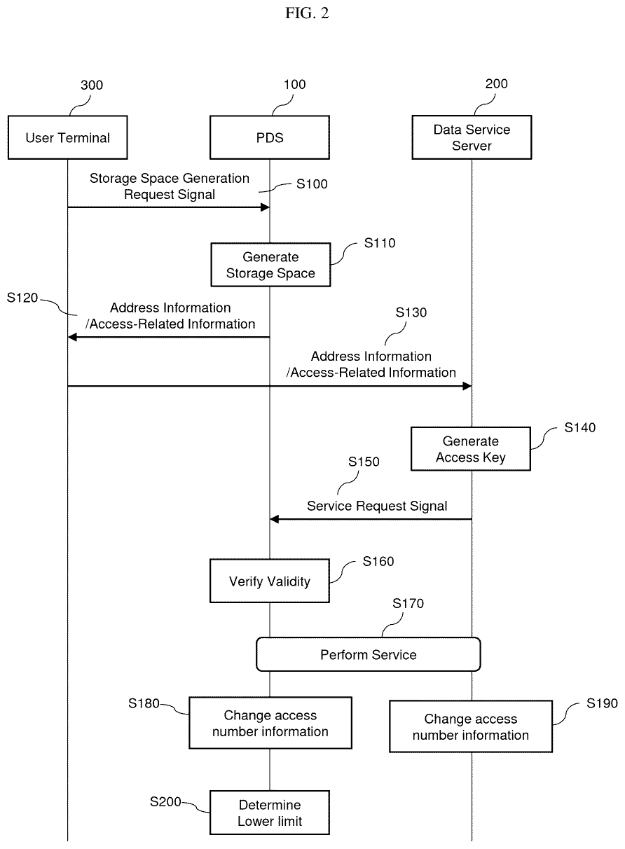

The specific operations of the system 10 will be described in more detail with reference to FIG. 2 and its following drawings.

FIG. 2 is a flowchart showing an embodiment of a method for providing personal information services through managing access key for controlling dynamic access to PDS that is performed by the system 10.

Referring to FIG. 2, first, the user terminal 300 transmits a storage space generation request signal to the PDS 100 in step S100.

Here, the storage space generation request signal is a signal requesting the PDS 100 to generate a space for storing user information about the user of the user terminal 300. The storage space generation request signal includes authentication information of the data service server 200 that will use the user information and access number information.

The authentication information of the data service server 200 may be, for example, digital certificate information. A digital certificate is a certificate issued by a certification authority, such as a financial institution, a public institution, or the like having public trust and it guarantees that the certificate holder is the person in question. That is to say, the digital certificate confirms the identity of the certificate holder.

For example, an SSL certificate for https communication may be used as the digital certificate. Furthermore, another digital certificate issued by a conventionally-known certification authority and having public trust may be used.

Alternatively, for example, a decentralized identifier (DID) digital certificate may be used as the authentication information of the data service server 200.

Since the digital certificate itself is not a direct target of the present invention and is well known in the prior art, a detailed description thereof will be omitted.

Meanwhile, the access number information indicates the maximum number of times access to the data service server 200 is allowed.

The access number information may include operation information which indicates the number of times each of read operation, write operation and modify operation for user information stored in the PDS 100 is allowed. Further, the access number information may be set differently for each data service server 200.

Read operation, write operation, and modify operation may be defined as follows:
Read operation: Reading the content of a file or subdirectory in the user storage space of the PDS 100
Write operation: Storing a new file or subdirectory in the user storage space of the PDS 100 (deleting or modifying the content of an existing file is not allowed)
Modify operation: Deleting or modifying an existing file in the user storage space of the PDS 100 or storing a new file or a new subdirectory

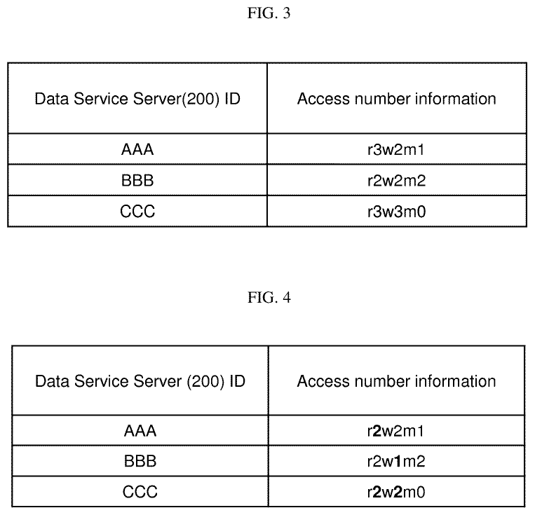

FIG. 3 shows an example of the access number information set for each data service server 200.

Referring to FIG. 3, the access number information having an identifier (ID) of “AAA” is “r3w2 ml.” Here, “r” indicates a read operation and “3” following “r” indicates that the read operation is allowed up to three times. Furthermore, “w” indicates a write operation and “2” following “w” indicates that the write operation is allowed up to two times. Also, “m” indicates a modify operation and “1” following “m” indicates that the modify operation is allowed up to one time.

In the same manner, it can be seen that the access number information having respective identifiers of “BBB” and “CCC” are also set to “r2w2m2” and “r3w3m0.”

The authentication information of the data service server 200 and the access number information may be set and transmitted via a user interface provided by the PDS 100.

Thereafter, the PDS 100 stores the authentication information of the data service server 200 and the access number information included in the storage space generation request signal and generates a user storage space for the user of the user terminal 300 in step S110.

Then, the PDS 100 transmits the address information of the user storage space, such as a URL indicating the location of the user storage space, and access-related information to the user terminal 300 in step S120.

In this case, the access-related information may include the access number information and time information. Here, the time information refers information about the time at which the access-related information is generated.

After receiving the address information of the user storage space and access-related information, the user terminal 300 transmits the received address information of the user storage space and access-related information to the data service server 200 in step S130.

The data service server 200 stores the received address information of the user storage space and access-related information for the user of the user terminal 300.

In this state, when the data service server 200 needs to request a service from the PDS 100, the data service server 200 generates an access key based on the access-related information and its own authentication information, that is, the authentication information of the data service server 200, in step S140.

The access key may be generated by the result value of a hash function having the access number information and the time information previously stored and the authentication information of the data service server 200 as its inputs.

After generating the access key, the data service server 200 transmits a service request signal including the generated access key to the PDS 100 in step S150.

The service request signal is a signal requesting the PDS 100 to perform a specific service. For example, the service request signal may be a signal requesting the PDS 100 to transmit at least a part of user information about the user of the user terminal 300 stored in the PDS 100.

In steps S160 and S170, after receiving the service request signal, the PDS 100 verifies the validity of the access key included in the service request signal and performs a service corresponding to the service request signal when the access key is valid.

In this case, the verification of the validity may be performed in the following manner.

First, the PDS 100 calculates the result value of the hash function having, as its inputs, the authentication information of the data service server 200 and the access number information stored previous step S100 and the time information used when the access-related information is generated.

Then, the PDS 100 compares the calculated result value with the access key transmitted from the data service server 200 and determines that the access key is valid when the calculated result value is identical to the access key.

Meanwhile, in step S180, the PDS 100 executes at least any one of read operation, write operation and modify operation for user information stored in the PDS 100 to perform the service corresponding to the service request signal and then updates the operation information for the executed operation by deducting the number of times the operation has been executed.

For example, when the data service server 200 needs to check the medical information of the user of the user terminal 300 stored in the PDS 100, the PDS 100 may read for the medical information for the user from the user information storage space by executing read operation and then transmit the read medical information to the data service server 200.

Here, since the PDS 100 has performed a read operation on the medical information by one time, the PDS 100 updates the operation information for read operation by deducting one accordingly.

FIG. 4 is a diagram showing a process of updating the access number information.

FIG. 4 shows a state in which a read operation has been performed once in the PDS 100 for the data service server 200 having an identifier “AAA” in the state of FIG. 3. It can be seen that compared to that of FIG. 3, the access number information for “AAA” has been changed to “r2w2 ml”.

Further, for the data service server 200 having an identifier of “BBB,” write operation was performed by one time in the PDS 100. Thus, compared to that of FIG. 3, the access number information for “BBB” has been changed to “r2w1m2.”

Moreover, for the data service server 200 having an identifier of “CCC,” one read operation and one write operation were performed in the PDS 100. Thus, compared to that of FIG. 3, the access number information for “CCC” has been changed to “r2w2m0.”

Meanwhile, in step S190, the data service server 200 also updates the access number information. That is to say, the data service server 200 updates the operation information for read operation, write operation and modify operation it stores by deducting the number of times each of the operation has been executed by the PDS 100.

Referring back to FIG. 2, in step S200, when the access number information reaches a preset lower limit (e.g., 0), the PDS 100 receives the access number information from the user terminal 300 again, generates new access-related information as described above and performs the steps following the step S120 again.

That is, the PDS 100 receives the access number information for data service server 200 from the user terminal 300 again, generates new access-related information, and transmits the access-related information to the data service server 200 via the user terminal 300.

According to the present invention, both the PDS 100 and the data service server 200 may dynamically change or update the access number information which indicates the maximum number of times access to the data service server 200 is allowed and mutually verify each other. Further, since the data service server 200 uses the access number information as an input to a hash function when generating an access key, when the access number information is incorrect, the access key is inconsistent accordingly. Thus, as a result, access to the PDS 100 is not allowed.

Therefore, by these procedures, it may become possible to check for a trace of illegal use by another person.

If the access number information is changed due to illegal use by another person, new access-related information is issued and transmitted to the data service server 200 in the manner described above. When the new access-related information is issued, the time information that is used when an access key is generated in the data service server 200 changes, so that an access key previously exposed to the other person does not work any longer.

In addition, according to the present invention, since the authentication information of the data service server 200 is used when an access key is generated, the possibility that an insider of the data service server 200 divulges the access number information to a third party without a user's consent may be reduced.

Although the exemplary embodiments of the present invention have been described above with reference to the accompanying drawings, it is obvious that the present invention is not limited to the above-described embodiments, but various modifications and variations may be made without departing from the spirit of the present invention.

What is claimed is:

1. A method for providing personal information services through managing access key for controlling dynamic access to Personal Data Store (PDS), the method comprising:
a first step of receiving, by a PDS, a storage space generation request signal from a user terminal;
a second step of storing, by the PDS, authentication information of a data service server and access number information indicating the maximum number of times access to the data service server is allowed included in the storage space generation request signal, generating, by the PDS, a user storage space, and then transmitting, by the PDS, address information of the user storage space and access-related information to the user terminal, wherein the user terminal transmits the address information of the user storage space and the access-related information to the data service server;
a third step of generating, by the data service server, an access key based on the access-related information and its own authentication information;
a fourth step of transmitting, by the data service server, a service request signal to the PDS, wherein the service request signal includes the access key; and
a fifth step of verifying, by the PDS, validity of the access key, and performing, by the PDS, a service corresponding to the service request signal when the access key is valid;
wherein the access-related information includes the access number information and time information.

2. The method of claim 1, wherein:
in the third step, the access key is a result value of a hash function having the access number information, the time information and the authentication information of the data service server as its inputs; and
in the fifth step, the PDS calculates the result value of the hash function having the authentication information of the data service server and the access number information stored previously and the time information used when the access-related information is generated as its inputs, compares the calculated result value with the access key transmitted from the data service server and determines that the access key is valid when the calculated result value is identical to the access key.

3. The method of claim 1, wherein the access number information includes operation information indicating the number of times each of read operation, write operation and modify operation for user information stored in the PDS is allowed.

4. The method of claim 3, wherein the PDS executes at least any one of read operation, write operation and modify operation for stored user information to perform the service corresponding to the service request signal and then updates the operation information for the executed operation by deducting the number of times the operation has been executed.

5. The method of claim 4, wherein the data service server updates the operation information for read operation, write operation and modify operation it stores by deducting the number of times the operation has been executed by the PDS.

6. The method of claim 4, wherein the PDS, when the access number information reaches a preset lower limit, receives the access number information from the user terminal again, generates new access-related information and performs steps following the third step.

7. A system for providing personal information services through managing access key for controlling dynamic access to Personal Data Store (PDS), the system comprising:
a PDS configured to receive a storage space generation request signal from a user terminal, to store authentication information of a data service server and access number information indicating the maximum number of times access to the data service server is allowed included in the storage space generation request signal, to generate a user storage space and to transmit address information of the user storage space and access-related information to the user terminal; and
the data service server configured to receive the address information of the user storage space and the access-related information from the user terminal;
wherein the data service server generates an access key based on the access-related information and its own authentication information and transmits a service request signal including the access key to the PDS;
wherein the PDS verifies validity of the access key and performs a service corresponding to the service request signal when the access key is valid; and
wherein the access-related information includes the access number information and time information.

8. The system of claim 7, wherein:
the access key is a result value of a hash function having the access number information, the time information and the authentication information of the data service server as its inputs; and
the PDS calculates the result value of the hash function having the authentication information of the data service server and the access number information stored previously and the time information used when the access-related information is generated as its inputs, compares the calculated result value with the access key transmitted from the data service server and determines that the access key is valid when the calculated result value is identical to the access key.

9. The system of claim 7, wherein the access number information includes operation information indicating the number of times each of read operation, write operation and modify operation for user information stored in the PDS is allowed.

10. The system of claim 9, wherein the PDS executes at least any one of read operation, write operation and modify operation for stored user information to perform the service corresponding to the service request signal and then updates the operation information for the executed operation by deducting the number of times the operation has been executed.

11. The system of claim 10, wherein the data service server updates the operation information for read operation, write operation and modify operation it stores by deducting the number of times the operation has been executed by the PDS.

12. The system of claim 10, wherein the PDS, when the access number information reaches a preset lower limit, receives the access number information from the user terminal again and generates new access-related information.
